(19) United States
(12) Patent Application Publication
(10) Pub. No.: US 2014/0285712 A1
(43) Pub. Date: Sep. 25, 2014

(54) CAMERA MODULE

(71) Applicant: Hackho Kim, Seoul (KR)

(72) Inventor: Hackho Kim, Seoul (KR)

(73) Assignee: LG INNOTEK CO., LTD., Seoul (KR)

(21) Appl. No.: 14/241,332

(22) PCT Filed: Aug. 24, 2012
(86) PCT No.: PCT/KR2012/006757

§ 371 Date: Feb. 26, 2014

(30) Foreign Application Priority Data
Aug. 31, 2011 (KR) 10-2011-0087666

(51) Int. Cl. H04N 5/225

(52) U.S. Cl. CPC H04N 5/2252
USPC 348/373

(57) ABSTRACT

An exemplary embodiment of the present invention is provided, the camera module including a housing embedded with a first lens unit including at least one lens, and a driving unit formed at the housing and bonded with a second lens unit including at least one lens, the second lens being optically aligned with the first lens unit, the driving unit including piezoelectric elements moving the second lens unit.

### TECHNICAL FIELD

The teachings in accordance with exemplary embodiments of this invention relate generally to a camera module.

### BACKGROUND ART

A camera module captures an optical image of a subject through a lens using an image sensor, and converts the optical image or an optical signal into an electrical signal to form an image. The camera module includes a lens driving device moving the lens to an optical axis direction, and the lens driving device uses a power generated by an actuator to move the lens to the optical axis direction and to adjust a focal length, whereby an autofocus function is realized.

Lens driving devices are known in the art. For example, Korea Patent Application Publication No. 2010-0025707 discloses a VCM (Voice Coil Motor) as one of lens driving devices. The VCM includes a bobbin, a coil, a permanent magnet and a yoke, where the bobbin and a lens barrel are screw-fastened, and the coil interacting with the permanent magnet is wound on a periphery of the bobbin to a direction perpendicular to a magnetic flux.

At this time, in a case a voltage is applied to the coil, a current flowing in the coil and a magnetic field of the permanent magnet are interacted to move the bobbin upwards of the optical axis direction, and the lens barrel simultaneously moves upwards to perform an autofocus function.

The VCM is mounted with a lot of parts, requires a high driving voltage, such that development of lens driving device capable of replacing the VCM is demanded.

### DISCLOSURE OF INVENTION

### Technical Problem

Accordingly, embodiments of the present invention may relate to a camera module that substantially obviates one or more of the above disadvantages/problems due to limitations and disadvantages of related art, and it is an object of the present invention to provide a camera module configured to reduce power consumption by using a piezo-electric element for autofocus driving.

Technical problems to be solved by the present invention are not restricted to the above-mentioned, and any other technical problems not mentioned so far will be clearly appreciated from the following description by skilled in the art.

### Solution to Problem

In order to accomplish the above object, an exemplary embodiment of the present invention provides a camera module, the camera module comprising: a housing embedded with a first lens unit including at least one lens; and a driving unit formed at the housing and bonded with a second lens unit including at least one lens, the second lens being optically aligned with the first lens unit, the driving unit including piezo-electric elements moving the second lens.

Preferably, but not necessarily, the driving unit includes a driving layer formed with a through hole and a peripheral area of the through hole being floated from bottom side, a second lens bonded to the floated peripheral area of the through hole, and piezo-electric elements formed on the driving layer to move upwards the floated peripheral area of the through hole.

Preferably, but not necessarily, the floated peripheral area of the through hole is formed with a cantilever unit.

Preferably, but not necessarily, the through hole formed at the driving unit takes a round shape.

Preferably, but not necessarily, a plurality of cantilever units is formed.

Preferably, but not necessarily, each cantilever unit faces the other cantilever unit.

Preferably, but not necessarily, the second lens unit is bonded to the driving unit using a bump.

Preferably, but not necessarily, the piezoelectric element is a piezoelectric capacitor formed with a bottom electrode, a piezoelectric membrane and an upper electrode.

Preferably, but not necessarily, the second lens unit is bonded to a distal end of the cantilever unit.

Preferably, but not necessarily, a plurality of openings is formed at the peripheral area of the through hole.

Preferably, but not necessarily, each of the openings is opened toward an inner wall of the through hole.

Preferably, but not necessarily, the peripheral area of the through hole is partitioned to a plurality of areas by the openings.

Preferably, but not necessarily, each of the partitioned peripheral areas of the through hole lifts each partitioned peripheral area in a deformed shape corresponding to each piezoelectric element.

### ADVANTAGEOUS EFFECTS OF INVENTION

A camera module according to an exemplary embodiment of the present invention has an advantageous effect in that autofocus is driven by piezoelectric elements to reduce power consumption. Another advantageous effect is that a lens is moved by piezoelectric elements to reduce noise. Still another advantageous effect is that autofocus is driven by piezoelectric elements to enable a linear driving. Still further advantageous effect is that a driving unit moving a lens is in membrane style to reduce foreign object and reliability issues.

### BRIEF DESCRIPTION OF DRAWINGS

The teachings of the present invention can be readily understood by considering the following detailed description in conjunction with the accompanying drawings, in which:

FIG. 1 is a partial cross-sectional view mimetically illustrating a camera module according to an exemplary embodiment of the present invention;

FIGS. 2a and 2b are partial cross-sectional views illustrating an operation for auto-focusing by a camera module according to an exemplary embodiment of the present invention;

FIG. 3 is a plan view mimetically illustrating a camera module according to a first exemplary embodiment of the present invention;

FIG. 4 is a plan view mimetically illustrating a camera module according to a second exemplary embodiment of the present invention;

FIG. 5 is a partial cross-sectional view mimetically illustrating a camera module according to the second exemplary embodiment of the present invention;

FIG. 6 is a partial cross-sectional views illustrating an operation for auto-focusing by a camera module of FIG. 5; and

FIG. 7 is a partial cross-sectional view mimetically illustrating a driving unit of a camera module according to an exemplary embodiment of the present invention.

### BEST MODE FOR CARRYING OUT THE INVENTION

The following description is not intended to limit the invention to the form disclosed herein. Consequently, variations and modifications commensurate with the following teachings, and skill and knowledge of the relevant art are within the scope of the present invention. The embodiments described herein are further intended to explain modes known of practicing the invention and to enable others skilled in the art to utilize the invention in such, or other embodiments and with various modifications required by the particular application(s) or use(s) of the present invention.

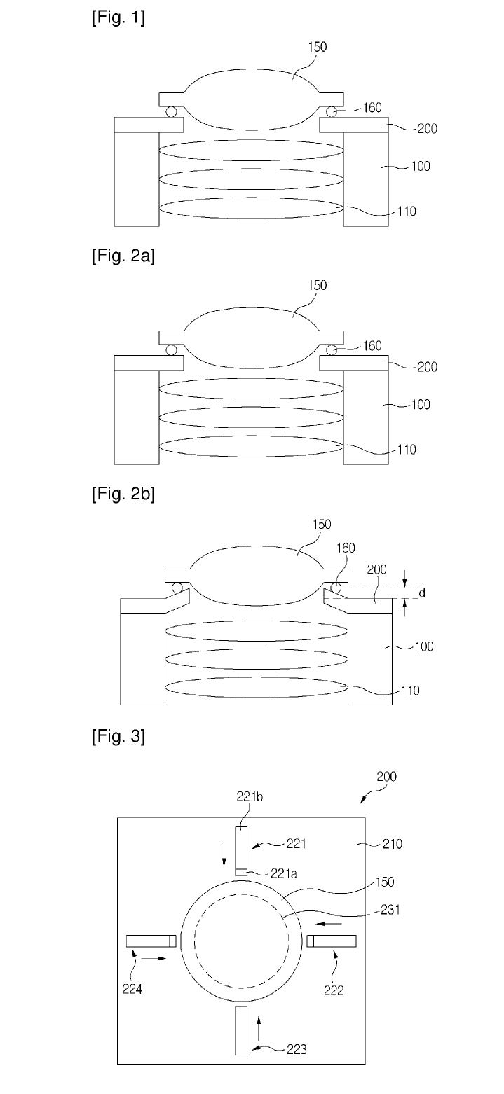

The disclosed embodiments and advantages thereof are best understood by referring to FIGS. 1-7 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented. Accordingly, the described aspect is intended to embrace all such alterations, modifications, and variations that fall within the scope and novel idea of the present invention.

It will be understood that the terms “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. That is, the terms “including”, “includes”, “having”, “has”, “with”, or variants thereof are used in the detailed description and/or the claims to denote non-exhaustive inclusion in a manner similar to the term “comprising”.

Furthermore, “exemplary” is merely meant to mean an example, rather than the best.

It is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated. That is, in the drawings, the size and relative sizes of layers, regions and/or other elements may be exaggerated or reduced for clarity. Like numbers refer to like elements throughout and explanations that duplicate one another will be omitted. Now, the present invention will be described in detail with reference to the accompanying drawings.

Words such as “thereafter,” “then,” “next,” “therefore”, etc. are not intended to limit the order of the processes; these words are simply used to guide the reader through the description of the methods.

It will be understood that when an element is referred to as being “connected” or “coupled” to another element, it can be directly connected or coupled to the other elements or intervening elements may be present. In contrast, when an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. For example, a first region/layer could be termed a second region/layer, and, similarly, a second region/layer could be termed a first region/layer without departing from the teachings of the disclosure.

The terminology used herein is for the purpose of describing particular embodiments only and is not intended to be limiting of the general inventive concept. As used herein, the singular forms “a”, “an” and “the” are intended to include the plural forms as well, unless the context clearly indicates otherwise.

Now, the camera module according to exemplary embodiments of the present invention will be described in detail with reference to the accompanying drawings.

FIG. 1 is a partial cross-sectional view mimetically illustrating a camera module according to an exemplary embodiment of the present invention, and FIGS. 2a and 2b are partial cross-sectional views illustrating an operation for auto-focusing by a camera module according to an exemplary embodiment of the present invention.

A camera module according to an exemplary embodiment of the present invention includes a housing (100) embedded with a first lens unit (110) including at least one lens; and a driving unit (200) mounted at the housing (100) and bonded with a second lens unit (150) including at least one lens, the second lens (150) being optically aligned with the first lens unit (110), the driving unit (200) including piezoelectric elements moving the second lens unit (150).

Thus, the camera module according to an exemplary embodiment of the present invention has an advantage in that the auto-focusing can be performed by moving the second lens unit (150), using the driving unit (200) formed with the piezoelectric elements.

That is, while no power is applied to the driving unit (200) as shown in FIG. 2a, if power is applied to the driving unit (200) as illustrated in FIG. 2b, the second lens unit (150) is upwardly moved by displacement generated by the piezoelectric elements to perform the auto focusing. At this time, as shown in FIG. 2b, displacement (d) is generated by the driving unit (200) to move the second lens unit (150). The second lens unit (150) is bonded to the driving unit (200) using a bump.

Thus, the camera module according to an exemplary embodiment of the present invention has an advantage in that power consumption can be reduced by driving the auto focusing using the piezoelectric elements. Furthermore, the camera module according to an exemplary embodiment of the present invention has an advantage in that lens unit is moved by using the piezoelectric elements to reduce noise.

FIG. 3 is a plan view mimetically illustrating a camera module according to a first exemplary embodiment of the present invention. The first exemplary embodiment of the present invention exemplifies a configuration of the driving unit (200), where the driving unit (200) includes a driving layer (210) centrally formed with a through hole (231), with a peripheral area of the through hole (231) being floated from bottom side, a second lens (150) bonded to the floated peripheral area of the through hole (231), and piezoelectric elements (221, 222, 223, 224) formed on the driving layer (210) to move upwards the floated peripheral area of the through hole.

In a case power is applied to the piezoelectric elements (221, 222, 223, 224) in the camera module according to the first exemplary embodiment of the present invention, displacement is generated from the piezoelectric elements (221, 222, 223, 224) and the displacement pushes the driving layer (210) to the through hole (231) (arrow direction in FIG. 3), whereby the floated peripheral area of the through hole (231) is moved upwards to move the second lens (150) upwards.

Referring to FIG. 3, each of the piezoelectric elements (221, 222, 223, 224) includes a piezoelectric membrane (221a), and an upper electrode (221b) formed on the piezo-electric membrane (221a), and the piezoelectric membrane (221a) is formed thereunder with a bottom electrode (not shown).

The through hole (231) may take a round shape. However, the shape of the through hole (231) is not limited to the round shape, and may take a variety of shapes.

The driving layer (210) is formed with a membrane region, because the peripheral area of the through hole (231) is floated, where the floating is defined by a bottom being removed to allow floating from a bottom surface, or may be interpreted as floating from the bottom surface, which makes the floated area the membrane region.

Furthermore, the peripheral area of the through hole (231) may be formed with a plurality of openings to allow displacement generated by each of the piezoelectric elements (221, 222, 223, 224) to be transmitted only to the peripheral area of the through hole (231), where the openings may be opened to an inward lateral wall of the through hole (231).

That is, the openings serve to transmit the displacement generated by each of the piezoelectric elements (221, 222, 223, 224) to be transmitted only to the peripheral area of the through hole (231). Furthermore, the peripheral area of the through hole (231) may be partitioned by a plurality of regions by the openings, where each of the partitioned peripheral areas of the through hole (231) corresponds to each of the piezo-electric elements (221, 222, 223, 224), and may be lifted upwards by deformation of each of the piezoelectric elements (221, 222, 223, 224). For example, each of the partitioned peripheral areas of the through hole (231) is lifted upwards by each corresponding piezoelectric element (221, 222, 223, 224). To be more specific, deformation generated by the each of the piezoelectric element (221, 222, 223, 224) lifts upwards the partitioned peripheral area of the through hole (231) corresponding to each corresponding piezoelectric element (221, 222, 223, 224).

Thus, the camera module according to a first exemplary embodiment of the present invention has an advantage in that the driving unit moving the lens is formed with a membrane style to have less foreign object-related and reliability-related issues.

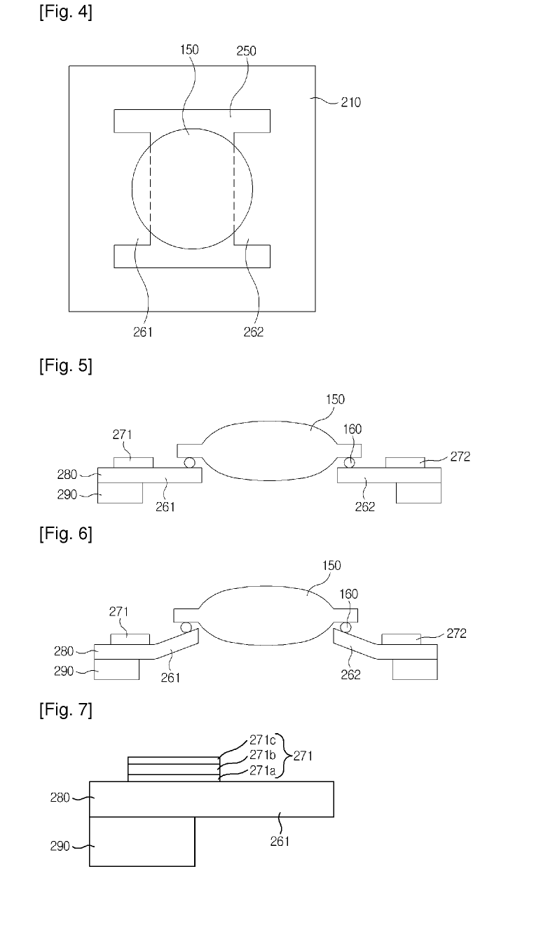

FIG. 4 is a plan view mimetically illustrating a camera module according to a second exemplary embodiment of the present invention.

The camera module according to the second exemplary embodiment of the present invention illustrates the driving layer (210) formed with a cantilever structure.

That is, as shown in FIG. 4, a partial area of the floated peripheral area of the through hole (231) is formed with cantilever units (261, 262). The cantilever structure is plurally (261, 262) formed, and each of the cantilever units (261, 262) faces the other unit. For example, the number of cantilever units (261, 262) may be two or four, and each unit faces the other unit and applies an even force to lift the second lens unit (150). The second lens unit (150) is bonded to a distal end of the cantilever units (261, 262), and when the cantilever units (261, 262) are lifted, the second lens unit (150) is also lifted to perform the auto focusing function.

### MODE FOR THE INVENTION

FIG. 5 is a plan view mimetically illustrating a camera module according to a second exemplary embodiment of the present invention, FIG. 6 is a partial cross-sectional views illustrating an operation for auto-focusing by a camera module of FIG. 5, and

FIG. 7 is a partial cross-sectional view mimetically illustrating a driving unit of a camera module according to an exemplary embodiment of the present invention.

As explained in the camera module according to a second exemplary embodiment of the present invention, the lens unit is auto focused by the cantilever structure.

That is, as illustrated in FIG. 5, a support unit (290) is formed with a driving layer (280), a through hole is formed at a center area of the driving layer (280), and a peripheral area of the through hole is floated from a bottom. Thus, the floated peripheral area of the through hole is formed with cantilever units (261, 262). Furthermore, an upper surface of the peripheral area of the through hole, i.e., an upper surface of the cantilever units (261, 262) is bonded with the second lens unit (150) via a bump (160). The driving layer (280) is formed with piezoelectric elements (271, 272) for lifting the cantilever units (261, 262).

Thus, as depicted in FIG. 6, the piezoelectric elements (271, 272) are driven to lift the cantilever units (261, 262) and the second lens unit (150). At this time, as shown in FIG. 7, the piezoelectric element (271) may be realized by a bottom electrode (271a), a piezoelectric membrane (271b) and an upper electrode (271c).

For example, in a case a nitride layer is formed at an upper surface of a silicone substrate, and a part of the silicone substrate is removed using MEMS (Micro Electro Mechanical System), a remaining area of the silicone substrate may be used as the support unit (290), and in a case the nitride layer is floated from the bottom to become a membrane and to be used as the driving layer (280), and in a case the nitride layer is etched to take a cantilever shape, the nitride layer may be used as the cantilever units (261, 262).

As explained above, the camera module according to an exemplary embodiment of the present invention is advantageous in that a linear driving is enabled, because piezo-electric elements are used to perform the auto focusing function.

The previous description of the present invention is provided to enable any person skilled in the art to make or use the invention. Various modifications to the invention will be readily apparent to those skilled in the art, and the generic principles defined herein may be applied to other variations without departing from the spirit or scope of the invention. Thus, the invention is not intended to limit the examples described herein, but is to be accorded the widest scope consistent with the principles and novel features disclosed herein.

### INDUSTRIAL APPLICABILITY

The camera module according to an exemplary embodiment of the present invention has an industrial applicability in that power consumption can be reduced, noise can be reduced and a linear driving is enabled.

1. A camera module, the camera module comprising: a housing embedded with a first lens unit including at least one lens; and a driving unit formed at the housing and bonded with a second lens unit including at least one lens, the second lens unit being optically aligned with the first lens unit, the driving unit including piezoelectric elements moving the second lens unit.

2. The camera module of claim 1, wherein the driving unit includes a driving layer formed with a through hole and a peripheral area of the through hole being floated from bottom side, a second lens unit bonded to the floated peripheral area of the through hole, and piezoelectric elements formed on the driving layer to move upwards the floated peripheral area of the through hole.

3. The camera module of claim 1, wherein the floated peripheral area of the through hole is formed with a cantilever unit.

4. The camera module of claim 1, wherein the through hole formed at the driving unit takes a round shape.

5. The camera module of claim 1, wherein a plurality of cantilever units is formed.

6. The camera module of claim 5, wherein each cantilever unit faces the other cantilever unit.

7. The camera module of claim 6, wherein the second lens unit is bonded to the driving unit using a bump.

8. The camera module of claim 7, wherein the piezoelectric element is a piezoelectric capacitor formed with a bottom electrode, a piezoelectric membrane and an upper electrode.

9. The camera module of claim 3, wherein the second lens unit is bonded to a distal end of the cantilever unit.

10. The camera module of claim 2, wherein a plurality of openings is formed at the peripheral area of the through hole.

11. The camera module of claim 10, wherein each of the openings is opened toward an inner wall of the through hole.

12. The camera module of claim 10, wherein the peripheral area of the through hole is partitioned to a plurality of areas by the openings.

13. The camera module of claim 3, wherein each of the partitioned peripheral areas of the through hole lifts each partitioned peripheral area in a deformed shape corresponding to each piezoelectric element.
